(19) United States
(12) Patent Application Publication
(10) Pub. No.: US 2016/0177901 A1
(43) Pub. Date: Jun. 23, 2016

(54) SPLIT FUEL RAIL ASSEMBLY FOR AN INTERNAL COMBUSTION ENGINE

(71) Applicant: WESTPORT POWER INC., Vancouver (CA)

(72) Inventors: Christopher DICKEN, Vancouver, CA (US); Michael C. WICKSTONE, Richmond (CA)

(21) Appl. No.: 14/900,990

(22) PCT Filed: Jun. 20, 2014
(86) PCT No.: PCT/CA2014/050582

§ 371 Date: Dec. 22, 2015

(30) Foreign Application Priority Data
Jun. 27, 2013 (CA) 2819718

(51) Int. Cl. F02M 55/02

(52) U.S. Cl. CPC F02M 55/025

(57) ABSTRACT

A split fuel rail assembly for an internal combustion engine comprises a first manifold and a second manifold connected through a connector which is directly joined to each of the manifolds and which has a cross bore fluidly connecting the first and the second manifold and a stem passage fluidly connected to a fuel supply line. The present split fuel rail assembly is easier to manufacture and assemble and can be easily installed on the cylinder head assembly of the engine, by directly mounting the split fuel rail assembly on the cylinder lead assembly without any intermediate connecting piping.

### TECHNICAL FIELD

The present disclosure relates to a split fuel rail assembly for supplying fuel to an internal combustion engine.

### BACKGROUND OF THE INVENTION

Many engine fuel systems employ a fuel injector for each combustion chamber. Fuel is stored in either liquid or gaseous form in a storage vessel and eventually delivered to the injectors via a fuel manifold. When one manifold is used to deliver the fuel to all of the injectors such an arrangement is known as a “common rail”.

Accordingly, a common rail fuel system normally employs a single manifold for an engine or a bank of cylinders, for example when an engine has two cylinder banks arranged in a V-configuration there can be a common rail for each cylinder bank. By way of example, U.S. Pat. No. 7,543,567 describes a common rail connected through a fuel line to a high pressure fuel source and through hollow tubes to the fuel injectors. The hollow tubes, sometimes referred to as “fuel swords” extend linearly from the common rail, and are configured to supply fuel from the common rail to each of the fuel injectors. Each hollow tube passes through a respective bore provided in the cylinder head.

Such arrangements for supplying fuel to the fuel injectors of an engine are known to be applied to any type of internal combustion engine, for example, engines that are fuelled with diesel, gasoline, gaseous fuel, or an engine that consumes more than one fuel. When an engine consumes two fuels, the first fuel can be a liquid fuel such as diesel and the second fuel can be a gaseous fuel such as natural gas.

Engines can be designed with a common rail that is in the form of an external manifold that is mounted next to the cylinder head. To modify an engine that was originally designed to be fuelled with just a liquid fuel to be fuelled with two fuels it is known to add a second external common rail. The length of the external common rail depends upon the number of cylinders in the engine. For example, in typical engine configurations, an engine can have a bank of cylinders comprising between two and eight cylinders, and engines with more cylinders require longer common rails to deliver fuel to each of the cylinders. Longer common rails are more difficult to manufacture compared to shorter common rails, and for longer configurations it can also be harder to ensure an even fuel distribution to each of the combustion chambers.

Accordingly, a need exists for an improved fuel rail that is easier to manufacture and install compared to known common rails. It is also preferred that the fuel rail is mounted on the engine in a manner that minimizes the space occupied by the combined engine and fuel rail assembly.

### SUMMARY

A split fuel rail assembly is disclosed for distributing fuel to a plurality of fuel injectors in an internal combustion engine. The split fuel rail assembly comprises a connector with internal fuel distribution passages in fluid communication with an inlet and a first and a second outlet, a first manifold joined directly to the first outlet, whereby a first elongated fuel passage defined within the first manifold is in fluid communication with the internal fuel distribution passage associated with the connector. The first manifold has at least one distribution passage for delivering fuel from the first elongated fuel passage to one of the plurality of fuel injectors. The split fuel rail assembly further comprises a second manifold joined directly to the second outlet whereby a second elongated fuel passage defined within the second manifold is in fluid communication with the internal fuel distribution passage associated with the connector. The second manifold has at least one distribution passage for delivering fuel from said second elongated fuel passage to one of the plurality of fuel injectors.

The first elongated fuel passage of the first manifold has a longitudinal axis that is aligned with a longitudinal axis of the second elongated fuel passage of the second manifold.

In preferred embodiments, the split fuel rail assembly comprises first and second manifolds of equal length, each manifold delivering fuel to the same number of fuel injectors.

The first and second manifolds are preferably formed to be mounted directly onto a cylinder head assembly with a fluid tight connection between each of the distribution passages associated with each of said first and second manifolds and corresponding fuel passages associated with each one of the plurality of fuel injectors.

The split fuel rail assembly can further comprise a second connector joined to the second manifold and a third manifold joined to the second connector opposite to the second manifold.

The first and second manifolds of the split fuel rail assembly are preferably machined from a block of metal, or they can be made from extruded metal with an end plug to seal open ends not connected to the connector. Alternatively, the first and second manifolds can be cast metal pieces.

The split fuel rail assembly described here can be associated a single bank of cylinders.

A method of installing a split fuel rail assembly on the cylinder head assembly of an internal combustion engine is described, the method comprising:
a. directly joining a first manifold to a first arm of a connector through a releasable connection;
b. directly joining a second manifold to a second arm of said connector through a releasable connection;
c. aligning lateral passages of each of said first and second manifolds to corresponding passages in the cylinder head assembly which are fluidly connected to the engine's injectors; and
d. mounting said assembly formed by the first manifold, the second manifold and the connector on the cylinder head assembly of the cylinder head assembly through releasable fasteners.

The method further comprises connecting a fuel supply conduit to a stem of the connector.

The split fuel rail assembly can be mounted directly on the engine's cylinder head.

### BRIEF DESCRIPTION OF THE DRAWINGS

The drawings illustrate specific preferred embodiments of the invention, but should not be considered as restricting the spirit or scope of the invention in any way.

FIG. 1 is an exploded perspective view of the present split fuel rail assembly as it is installed on the cylinder head assembly of an internal combustion engine;

FIG. 2 illustrates a side and bottom view of the split fuel rail assembly and an enlarged cross-sectional view through the T-shaped connector that connects the first and second manifolds of the split fuel rail assembly.

FIG. 3 illustrates a cross-sectional side view of the split fuel rail assembly mounted directly on the cylinder head assembly of an internal combustion engine.

FIG. 4 illustrates a cross-sectional side view of the split fuel rail assembly mounted directly on the cylinder head assembly and fluidly connected to a fuel sword which communicates with an internal passage in the cylinder head connecting to engine's fuel injectors.

### DETAILED DESCRIPTION OF THE PREFERRED EMBODIMENTS

The split fuel rail assembly illustrated in the preferred embodiments can be employed by internal combustion engines that use different types of fuel, for example an engine fuelled with diesel, gasoline or a gaseous fuel. The subject split fuel rail assembly is particularly advantageous when installed on a conventional mono-fuel internal combustion engine that is adapted for operating with two fuels, because with such engines there can be space restrictions which favor a more compact arrangement and there can be limitations on the modifications that can be made to the engine to accommodate a second fuel manifold. Engines adapted to be fueled with two fuels can be either a bi-fuel engine, meaning an engine that is capable of being fueled with either one of two different fuels, or a dual fuel engine, meaning an engine that can be fuelled with two different fuels at the same time, or a hybrid which operates sometimes as a bi-fuel engine and sometimes as a dual fuel engine. By way of example, an engine that can be fuelled with two fuels is an engine that can be fuelled with a first fuel being a gaseous fuel, such as natural gas, hydrogen, propane, ethane, butane, methane or blends thereof and/or a second fuel being a liquid fuel such as gasoline, diesel fuel, dimethylether, bio-diesel or kerosene.

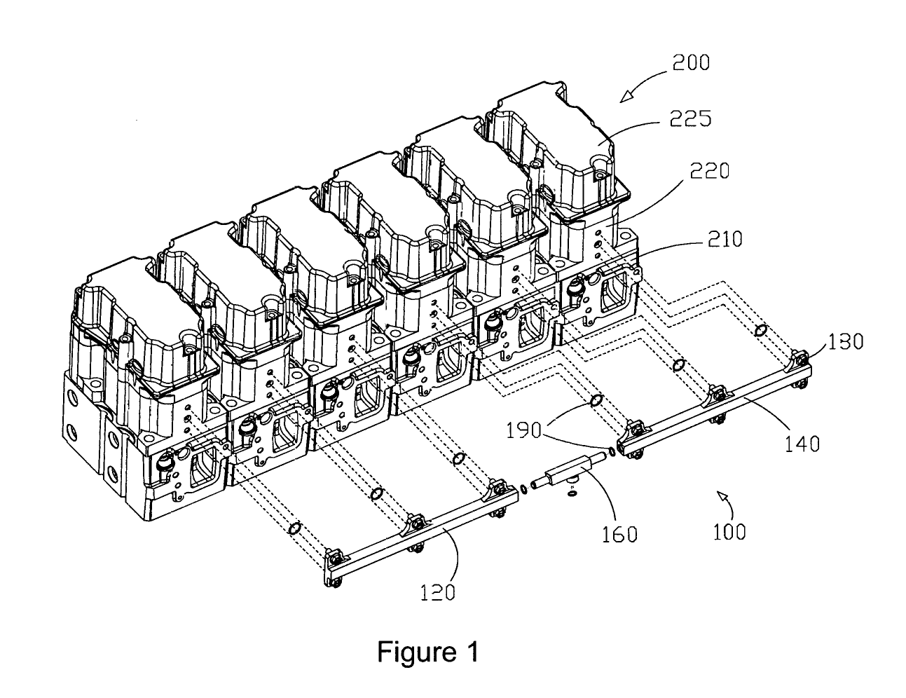

Referring to the drawings, FIG. 1 shows an exploded view of a preferred embodiment of the subject split fuel rail assembly in relation to a cylinder head assembly that is associated with an internal combustion engine that has a bank of six cylinders. Split fuel rail assembly 100 is installed on cylinder head assembly 200 which comprises a base cylinder head that is mountable to an engine block (not shown) to cover the six cylinders (not shown). Cylinder heads can be made from individual pieces with one associated with each cylinder, as shown in FIG. 1 or a cylinder head can be made as one structural unit that covers all of the cylinders in an engine block. In the illustrated embodiment cylinder head assembly 200 further comprises spacer 220 that extends the height of assembly 200 to accommodate a longer fuel injection valve and space for delivering a second fuel. Cylinder head assembly also comprises valve covers 225 which protect valve assemblies from dust, water and other contaminants. An advantage of having individual cylinder heads for each combustion chamber is that it forms a modular assembly that can be used by engines with any number of cylinders. The subject fuel manifold assembly can be employed with all types of cylinder head assemblies, but is more advantageous for engines that have larger cylinders or more cylinders. Depending on the space available, in preferred embodiments the split fuel rail assembly is mounted directly on the cylinder head and close to where the fuel injectors are mounted.

Split fuel rail assembly 100 comprises first manifold 120 and second manifold 140 which are fluidly connected through connector 160. In this preferred embodiment, split fuel rail assembly 100 is installed entirely on cylinder head assembly 200. Releasable fasteners 180, such as bolts, attach split fuel rail assembly 100 to cylinder head assembly 200. First and second manifolds 120 and 140 are hollow to allow fuel to flow to openings associated with each cylinder, and are sealed except for these openings and an inlet that forms a fluid tight connection with the fuel passages within connector 160. In preferred embodiments, seals 190 are provided at the interface between connector 160 and first and second manifolds 120 and 140 and between split fuel rail assembly 100 and cylinder head assembly 200.

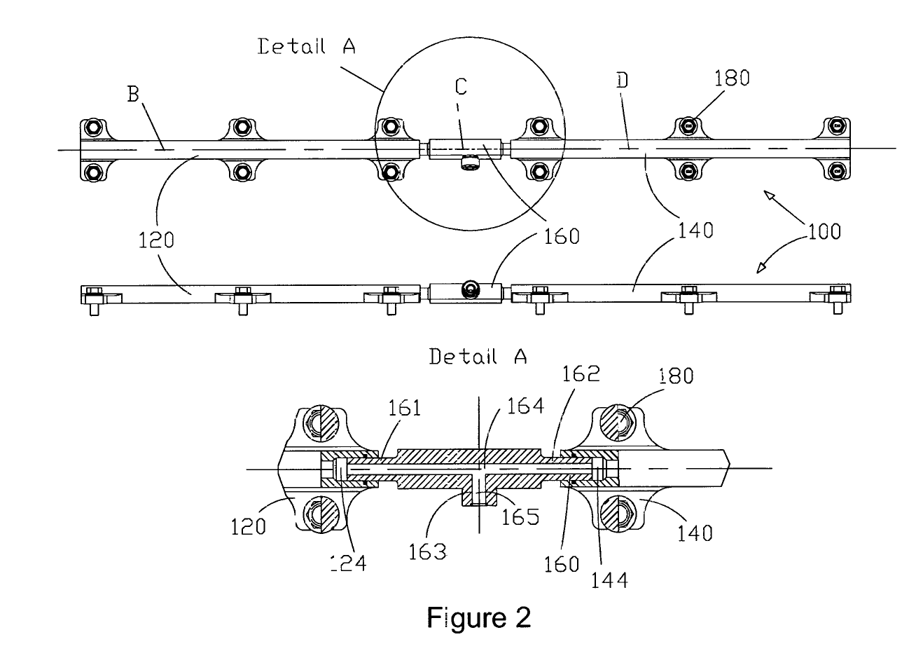

FIG. 2 illustrates a side and bottom view of split fuel rail assembly 100 and a cross-sectional view of detail “A” of the assembly, showing a cross-section through connector 160 and a partial cross-section through manifolds 120 and 140. Connector 160 comprises a first arm 161 that forms a fluid tight connection with first manifold 120, a second arm 162 that forms a fluid tight connection with second manifold 140 and a stem 163 which provides an inlet to which a fuel supply line can be connected. Connector 160 has cross bore 164 which fluidly connects first and second manifolds 120 and 140 and stem passage 165 in fluid communication with cross bore 164. Cross bore 164 is fluidly connected to first manifold passage 124 and to second manifold passage 144. Connector 160 is joined directly to first and second manifolds 120 and 140 through a releasable connection to provide a more compact assembly and to avoid any intermediate piping and the additional joints that would be associated with such piping.

In the illustrated figures, connector 160 has a “T” shape whereby first and second arms 161 and 162 form a 90 degree angle with stem 163. In the illustrated figures, longitudinal axis “B” of first manifold 120 is aligned with longitudinal axis “D” of second manifold 140 and with cross axis “C” of connector 160. The disclosed construction of the split fuel rail assembly comprises pieces that are easy to manufacture and connector 160 can be used with different manifolds to be employed with different engine geometries allowing for larger scale production of connector 160.

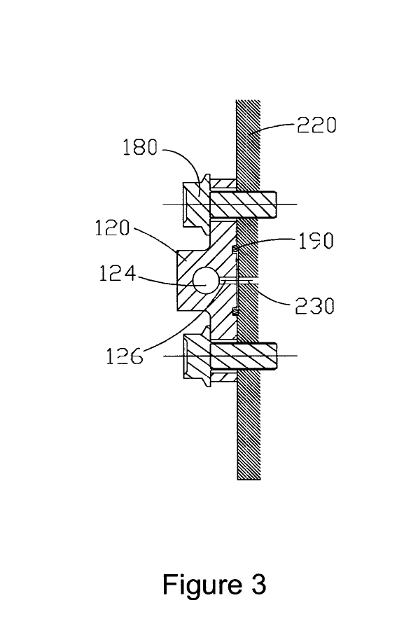

FIG. 3 illustrates a cross-sectional view of first manifold 120 mounted on cylinder head assembly 200 of an engine. In this illustrated example, the engine can comprise spacer 220 that is mounted on top of cylinder head 210, as shown in FIG. 1, with spacer 220 having an internal passage 230 for delivering fuel to the fuel injector, or the cylinder head itself can comprise such an internal passage and first manifold 120 can be mounted to the exterior wall of cylinder head 210 in essentially the same manner. In this embodiment, bolts 180 attach first manifold 120 to spacer 220 or a cylinder head assembly 200. As shown in FIG. 3, first manifold 120 is mounted directly on the surface of spacer 220. When first manifold 120 is mounted as shown, first manifold passage 124 is in fluid communication with lateral fuel passage 126, which is aligned with fuel passage 230. Fuel passage 230 is part of the internal passage within cylinder head assembly 200, which is fluidly connected to one of the engine's fuel injectors. Seal 190 provides sealing between first manifold 120 and spacer 220. Second manifold 140 has a similar construction and is mounted in the same manner, extending from connector 160 in the opposite direction.

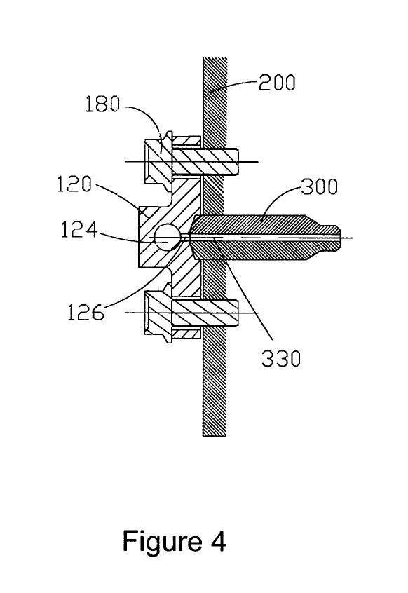

Other engines, which do not have such internal passages in the cylinder head to connect the fuel manifold to the fuel injectors, as previously described in relation to FIG. 3, can use fuel swords for connecting the fuel manifold to the fuel injectors, and with such embodiments first and second manifolds 120 and 140 function in essentially the same way to distribute fuel to each fuel injector for each cylinder. Such an embodiment is illustrated in FIG. 4 where fuel sword 300, which is provided with fuel passage 330, is mounted in cylinder head assembly 200. Fuel passage 330 in fuel sword 300 fluidly connects first manifold passage 124 to an internal passage in the cylinder head which is fluidly connected to the fuel injectors.

First and second manifolds 120 and 140 illustrated in FIGS. 1 to 4 can be machined from a metal block, extruded metal, or can be cast metal.

Split fuel rail assembly 100, illustrated in FIGS. 1 and 2, comprises two manifolds 120 and 140. In other embodiments, herein described but not illustrated, the subject split fuel rail assembly can comprise a plurality of connectors and associated manifolds, for example with three manifolds connected by two connectors (that is, for a single bank of cylinders, the split fuel rail assembly can comprise a first manifold connected to a first connector, which is also connected to a second manifold, with the second manifold being connected at an opposite end to a second connector, with the second connector being connected to a third manifold. For other engines that have a plurality of cylinder banks, there can be one split fuel rail assembly for each cylinder bank

A method is disclosed for installing a split fuel rail assembly on an internal combustion engine. The method comprises directly joining first manifold 120 to first arm 161 of connector 160 through a releasable connection, directly joining second manifold 140 to second arm 162 of connector 160 through a releasable connection, connecting a fuel supply conduit to stem 163 of connector 160, aligning lateral passages 126 in manifolds 120, 140 to corresponding fuel passage 230 in the cylinder head assembly which supplies fuel to a fuel inlet of the fuel injectors that inject fuel into the engine, and mounting the split fuel rail assembly thus formed on the cylinder head assembly through releasable fasteners, such as bolts. In some embodiments, manifolds 120 and 140 can be joined to connector 160 with a threaded connection.

For embodiments comprising more than two manifolds the modular construction of the fuel manifold assembly facilitates the assembly of different configurations for different engines using the same assembly method, by simply adding more pieces in the same manner.

In preferred embodiments, the split fuel rail assembly is mounted directly on the cylinder head assembly of the engine so that no additional piping is required between the fuel manifold assembly and the fuel passages leading to the respective fuel inlets of the fuel injectors.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

We claim:

1. A split fuel rail assembly for distributing fuel to a plurality of fuel injectors in an internal combustion engine, said split fuel rail assembly comprising:
a connector with internal fuel distribution passages in fluid communication with an inlet and a first and a second outlet;
a first manifold joined directly to said first outlet, whereby a first elongated fuel passage defined within said first manifold is in fluid communication with said internal fuel distribution passage associated with said connector, said first manifold having at least one distribution passage for delivering fuel from said first elongated fuel passage to one of said plurality of fuel injectors; and
a second manifold joined directly to said second outlet whereby a second elongated fuel passage defined within said second manifold is in fluid communication with said internal fuel distribution passage associated with said connector, said second manifold having at least one distribution passage for delivering fuel from said second elongated fuel passage to one of said plurality of fuel injectors.

2. The split fuel rail assembly of claim 1 wherein said first elongated fuel passage has a longitudinal axis that is aligned with a longitudinal axis of said second elongated fuel passage.

3. The split fuel rail assembly of claim 1 wherein said first and second manifolds are equal in length and each deliver fuel to the same number of fuel injectors.

4. The split fuel rail assembly of claim 1 wherein said first and second manifolds are each formed to be mounted directly onto a cylinder head assembly with a fluid tight connection between each of said distribution passages associated with each of said first and second manifolds and corresponding fuel passages associated with each one of said plurality of fuel injectors.

5. The split fuel rail assembly of claim 1 further comprising a second connector joined to said second manifold and a third manifold joined to said second connector opposite to said second manifold.

6. The split fuel rail assembly of claim 1 wherein said first and second manifolds are machined from a block of metal.

7. The split fuel rail assembly of claim 1 wherein said first and second manifolds are made from extruded metal with an end plug to seal open ends not connected to said connector.

8. The split fuel rail assembly of claim 1 wherein said first and second manifolds are cast metal pieces.

9. The split fuel rail assembly of claim 1 wherein said plurality of fuel injectors are associated with a single bank of cylinders

10. A method of installing a split fuel rail assembly on a cylinder head assembly of an in combustion engine complying.
a. directly joining a first manifold to a first arm of a connector through a releasable connection;
b. directly joining a second manifold to a second arm of said connector through a releasable connection,
c. aligning lateral passages of each of said first and second manifolds to corresponding passages in said cylinder head assembly which are fluidly connected to said engine's injectors; and
d. mounting said assembly formed by said first manifold, said second manifold and said connector on said cylinder head assembly through releasable fasteners.

11. The method of claim 10 further comprising connecting a fuel supply conduit to a stem of said connector.

12. The method of claim 10 wherein said assembly is mounted directly on a cylinder head of said engine.
